(19) United States
(12) Patent Application Publication
(10) Pub. No.: US 2006/0260117 A1
(43) Pub. Date: Nov. 23, 2006

(54) Method for manufacturing an open hollow bicycle crank

(75) Inventor: Chuan-Feng Chen, Taichung Hslen (TW)

Correspondence Address: TROXELL LAW OFFICE PLLC, SUITE 1404, 5205 LEESBURG PIKE, FALLS CHURCH, VA, 22041, US

(73) Assignee: Ourway Engineering Co., Ltd.

(21) Appl. No.: 11/132,232

(22) Filed: May 19, 2005

(51) Int. Cl. B23P 13/04

(52) U.S. Cl. 29/557

(57) ABSTRACT

A method for manufacturing an open hollow bicycle crank, whose steps comprises: (1) a step for primary molding of the crank: to place the raw materials for the hollow crank in a die and forge them with a metal forming machine for primary molding, and make them form a front end and back end, further the back end would be made open while the front end be a perforation to combine with the bicycle petals; and (2) a step to make the interior of the crank be hollow: in the preparation of making the back end of the crank be open, to make it hollow by means of drilling or other ways along with the axis of the interior of the crank from the center of the front end; and (3) a step to forge the back end of the crank: after making the interior of the crank hollow, to forge the back end of the open crank to make the back end of the crank open for the combination the spindle in the five-way pipe of the bicycle frame. After finishing the foregoing manufacture steps, the light open hollow bicycle crank can be obtained easily.

### BACKGROUND OF THE INVENTION

1) Field of the Invention

The present invention mainly provides a method for manufacturing an open hollow bicycle crank. And the open bicycle crank can be made hollow with this method and the crank would be light in weight.

2) Description of the Prior Art

Generally, the prior methods for manufacturing an open bicycle crank 2, referring to the FIG. 3, are mainly to make it by means of casting or forging, and set a perforation 21 at the front end of the crank 2 after the directly completion of the integrative crank 2 for its combination and position with spindles of petals (the drawings for it are not available). And the back end is designed open 22 for the combination and position with the spindle in the five-way pipe of the bicycle frame (the drawings for it are not available).

Nevertheless, we find out that the prior open crank 2 is solid that would make the whole crank have a certain weight and be heavy. Nowadays, the lightness of the bicycle is emphasized increasingly. And manufacturers are pursuing how to make their products light. Therefore the defect in considerable weight should be solved.

In addition, because the whole crank is solid causing the increased costs in raw materials virtually, this problem should be solved.

### SUMMARY OF THE INVENTION

In consideration of the foregoing defect of the conventional method to manufacture the open bicycle crank by means of casting, the inventor of the present invention developed a kind of method for manufacturing the open crank. It is approved that it can be implemented through many tests. Therefore we file this application for a patent. In which:

The main purpose of the present invention is to provide a method for manufacturing an open hollow bicycle crank, and the steps comprise (1) a step for primary molding of the crank, (2) a step to make the interior of the crank be hollow and (3) a step to forge the back end of the crank. After the three steps the open hollow crank can be obtained easily.

### BRIEF DESCRIPTION OF THE DRAWINGS

FIG. 1: The flow chart of the present invention.

FIG. 2-A: The three-dimensional sketch map of primary molding of the crank of the present invention.

FIG. 2-B: The sketch map of making the back end open while the interior of the crank hollow in accordance with the present invention.

FIG. 2-C: The sketch map of forging and molding of the back end of the crank of the present invention.

FIG. 3: The sketch map for illustrating the appearance of the prior open bicycle crank.

### DETAILED DESCRIPTION OF THE PREFERRED EMBODIMENTS

For your deep understanding of the present invention, the method would be described as reference with drawings as follows.

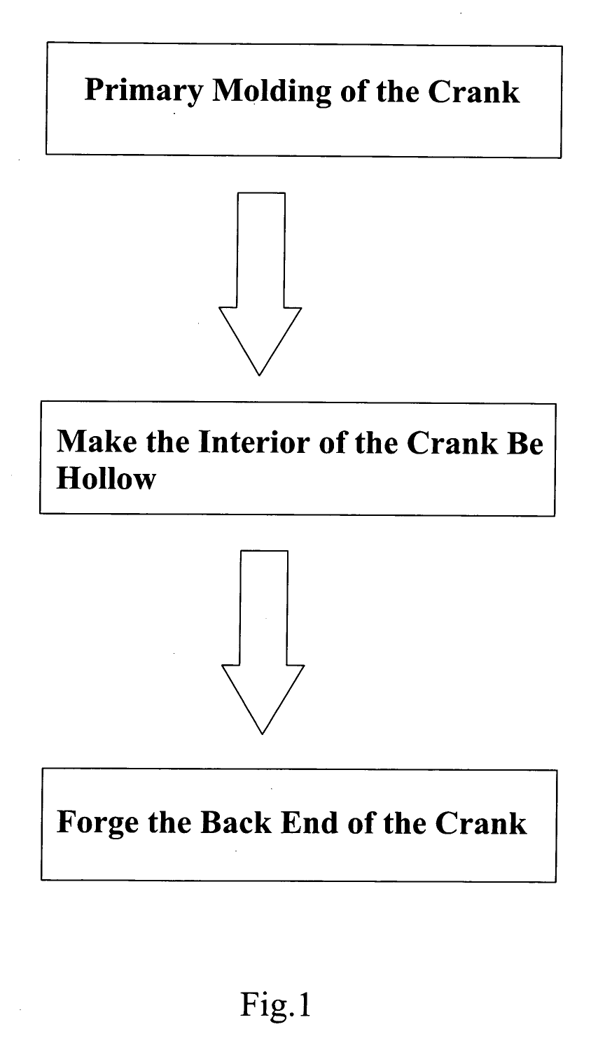

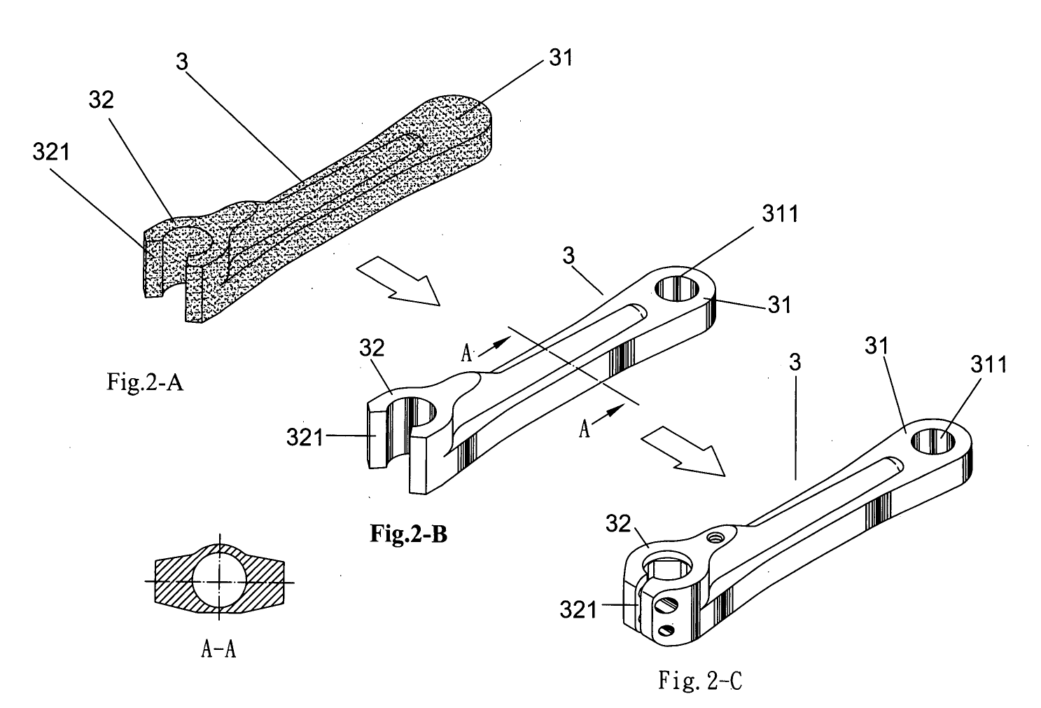

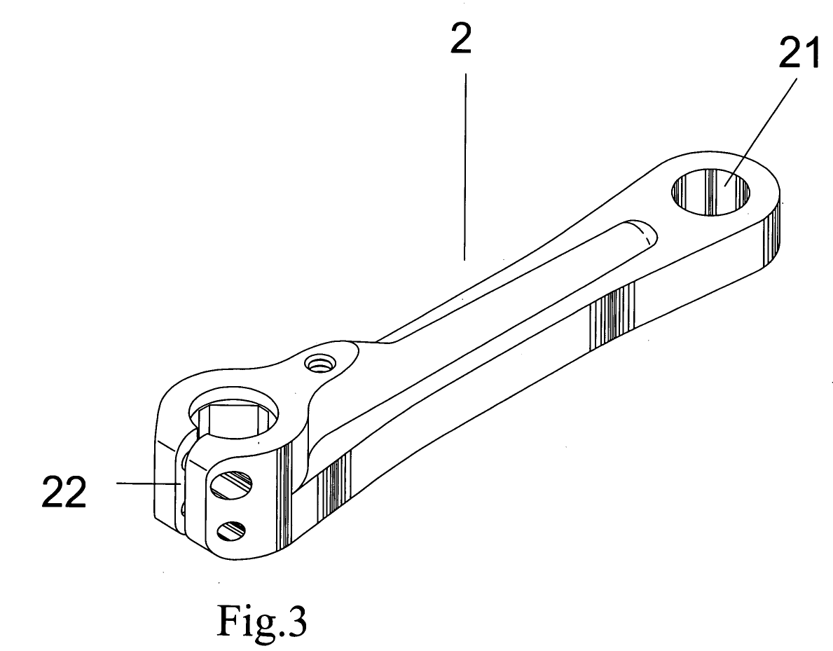

Referring to the FIG. 1, FIG. 2-A, FIG. 2-B and FIG. 2-C, the present invention mainly provides a method for manufacturing an open hollow bicycle crank, whose steps comprise:
(1) a step for primary molding of the crank 3: to place the raw materials for the hollow crank in a die and forge them with a metal forming machine for primary molding, and make them form a front end 31 and back end 32, further the back end 32 would be made open 321 while the front end 31 be a perforation 311 to combine with the bicycle petals (the drawings for it are not available); and
(2) a step to make the interior of the crank 3 be hollow: in the preparation of making the back end 32 of the crank 3 be open, to make it hollow 33 by means of drilling or other ways along with the axis of the interior of the crank 3 from the center of the front end; and
(3) a step to forge the back end 32 of the crank 3: after making the interior of the crank 3 hollow, to forge the back end 32 of the open crank 321 to make the back end 32 of the crank 3 open for the combination with the spindle in the five-way pipe of the bicycle frame.

Moreover, after finishing the foregoing manufacture steps, the defect of the considerable weight and increased costs in the raw materials of the conventional solid crank can be solved, and a light and simple open hollow crank can be obtained easily while the costs in the raw materials can be reduced.

What is claimed is:

1. A method for manufacturing an open hollow bicycle crank, whose steps comprises:
(1) a step for primary molding of the crank: to place the raw materials for the hollow crank in a die and forge them with a metal forming machine for primary molding, and make them form a front end and back end, further the back end would be made open while the front end be a perforation to combine with the bicycle petals; and
(2) a step to make the interior of the crank be hollow: in the preparation of making the back end of the crank be open, to make it hollow by means of drilling or other ways along with the axis of the interior of the crank from the center of the front end; and
(3) a step to forge the back end of the crank: after making the interior of the crank hollow, to forge the back end of the open crank to make the back end of the crank open for the combination the spindle in the five-way pipe of the bicycle frame.
After finishing the foregoing manufacture steps, the light open hollow bicycle crank can be obtained easily.
